(19) United States
(12) Patent Application Publication
(10) Pub. No.: US 2012/0190782 A1
(43) Pub. Date: Jul. 26, 2012

(54) DUAL COLOR ELECTRONICALLY ADDRESSABLE INK

(76) Inventors: Zhang-Lin Zhou, Palo Alto, CA (US); Jeffrey Todd Mabeck, Corvallis, OR (US); Richard H. Henze, San Carlos, CA (US)

(21) Appl. No.: 13/386,693

(22) PCT Filed: Oct. 16, 2009
(86) PCT No.: PCT/US09/60989

§ 371 Date: Jan. 24, 2012

(51) Int. Cl. C09D 11/00

(52) U.S. Cl. 524/236

(57) ABSTRACT

A dual color electronically addressable ink includes a non-polar carrier fluid, a first colorant of a first color, and a second colorant of a second color that is different than the first color. The first colorant includes a particle core, and a basic functional group attached to a surface of the particle core. The second colorant includes a particle core, and an acidic functional group attached to a surface of the particle core. The acidic functional group and the basic functional group are configured to interact within the non-polar carrier fluid to generate a charge on the first colorant and an opposite charge on the second colorant.

### BACKGROUND

The present disclosure relates generally to dual color electronically addressable inks.

Electronic inks are commonly used in electronic displays. Such electronic inks often include charged colorant particles that, in response to an applied electric field, rearrange within a viewing area of the display to produce desired images.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 depicts a generic mechanism for forming an embodiment of a dual color electronically addressable ink;

FIG. 2 depicts a synthetic methodology for forming sterically hindering polymeric charge controlling agents for use in embodiments of the dual color electronically addressable ink;

FIG. 3 depicts an example of a reaction mechanism for forming different embodiments of the dual color electronically addressable ink;

FIG. 4A is a cross-sectional schematic view of an embodiment of a multi-layer system incorporating embodiments of the dual color electronically addressable ink;

FIG. 4B is a cross-sectional schematic view of an embodiment of another multi-layer system incorporating an embodiment of the dual color electronically addressable ink in combination with a single color electronically addressable ink;

FIG. 5 depicts a generic mechanism for forming an embodiment of a surface modified black pigment and two mechanisms for obtaining a negatively charged surface modified black pigment;

FIG. 6 depicts an example of the mechanism for forming an embodiment of a negatively charged surface modified black pigment;

FIG. 7 depicts another generic mechanism for forming an embodiment of a surface modified black pigment and obtaining a negatively charged surface modified black pigment; and

FIG. 8 depicts an example of the mechanism for forming an embodiment of a surface modified black pigment and two mechanisms for obtaining a negatively charged surface modified black pigment.

### DETAILED DESCRIPTION

Embodiment(s) of the electronically addressable inks disclosed herein are dual color systems in which one of the colorants is positively charged, and the other of the colorants is negatively charged. It is believed that these inks are stabilized via minimum mobile charges (i.e., the charged colorant particles therein). The respective movement (e.g., in and out of view in a display) of the oppositely charged colorants may be controlled by applying a suitable electric field (i.e., the display is driven by electrophoresis and/or electro-convective flow). The dual color systems may be used in layered electro-optical display architectures, which enable the ability to address every available color at every location in the display. This tends to produce brighter and more colorful images. Furthermore, since at least one layer of the display architecture includes two colors, fewer layers are needed to achieve multi-colored displays (e.g., two layers are utilized to achieve a full-color display using combinations of the subtractive primaries (i.e., cyan, magenta, and yellow), and in some embodiments, also black). The reduced number of layers is also advantageous to decrease manufacturing costs. It is to be understood that the dual color systems may also be incorporated into displays or other devices with single color systems/layers.

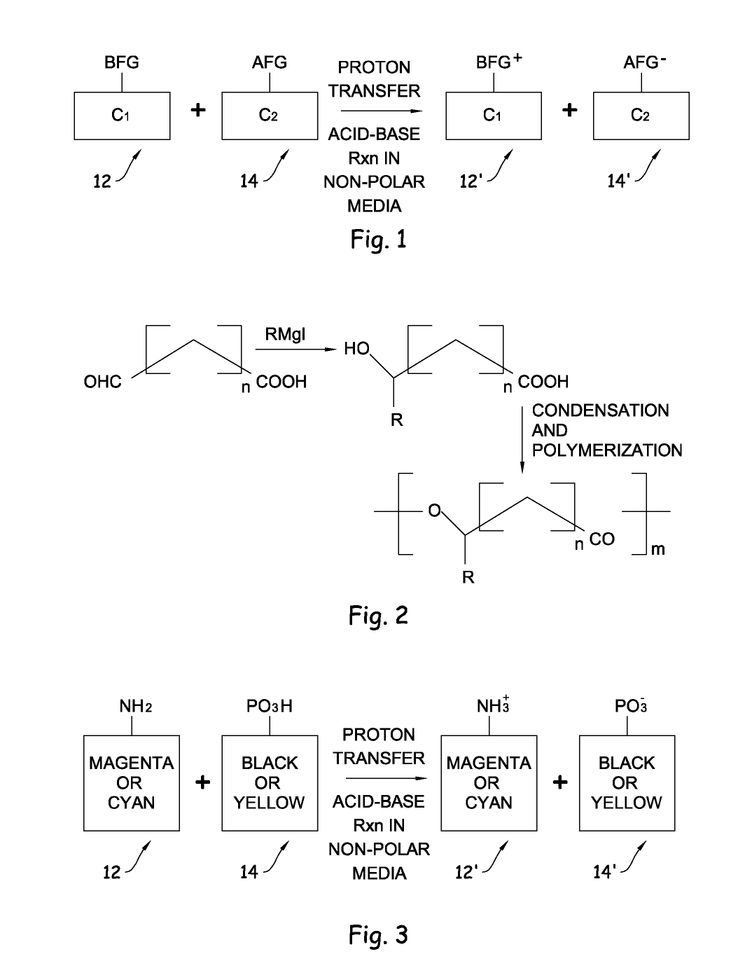

Referring now to FIG. 1, an embodiment of a mechanism for forming the dual color electrically addressable ink is illustrated. While not shown in FIG. 1, it is to be understood that the ink includes a non-polar carrier fluid (i.e., a fluid having a low dielectric constant k, which is less than 20). Such fluids tend to reduce leakages of electric current when driving a display including the ink, as well as increase the electric field present in the fluid when a voltage is applied thereto. It is to be understood that when used in an electro-optical display, the carrier fluid is the fluid or medium that fills up a viewing area defined in the display. More generally, the carrier fluid is configured to carry two different colored and oppositely charged colorant particles therein. In one embodiment, the non-polar carrier fluid is an isotropic solvent. Examples of suitable non-polar carrier fluids include, but are not limited to, hydrocarbons, halogenated or partially halogenated hydrocarbons, oxygenated fluids, and/or silicones. Some specific examples of non-polar solvents include perchloroethylene, halocarbons (such as halocarbon 0.8, halocarbon 1.8, halocarbon 4.2, and halocarbon 6.3), cyclohexane, dodecane, mineral oil, isoparaffinic fluids (such as those in the ISOPAR® series available from Exxon Mobile Corp., Houston, Tex., such as ISOPAR® L, ISOPAR®M, ISOPAR®G, and ISOPAR®V), siloxanes (e.g., cyclopentasiloxane and cyclohexasiloxane), and combinations thereof.

Since the electrically addressable ink may be subjected to electrophoretic actuation, it is desirable that the selected colorants exhibit dispersibility and desirable charge properties in the selected non-polar carrier fluid. As shown in FIG. 1, in the dual color ink, two differently colored colorants 12 and 14 are selected. Non-limiting examples of the different colors that may be selected for a single electrically addressable ink include magenta and black, cyan and yellow, magenta and cyan, orange and blue, red and white, green and white, blue and white, yellow and white, or any other combinations of such colors.

The two differently colored colorants 12, 14 each have a particle core C₁, C₂. The particle cores C₁, C₂ may be selected from organic pigments, inorganic pigments, or polymer particles colored with dye molecules, which are self-dispersible or non-self-dispersible in the non-polar carrier fluid. When non-self-dispersible colorants are used, the ink also includes one or more suitable dispersants. Such dispersants include hyperdispersants such as those of the SOLSPERSE® series manufactured by Lubrizol Corp., Wickliffe, Ohio (e.g., SOLSPERSE® 3000, SOLSPERSE® 8000, SOLSPERSE® 9000, SOLSPERSE® 11200, SOLSPERSE® 13840, SOLSPERSE® 16000, SOLSPERSE® 17000, SOLSPERSE® 18000, SOLSPERSE® 19000, Solsperse® 21000, and SOLSPERSE® 27000); various dispersants manufactured by BYK-chemie, Gmbh, Germany, (e.g., DISPERBYK® 110, DISPERBYK® 163, DISPERBYK® 170, and DISPERBYK® 180); various dispersants manufactured by Evonik Industries AG, Germany, (e.g., Tego 630, Tego 650, Tego 651, Tego 655, Tego 685, and Tego 1000); and various dispersants manufactured by Sigma-Aldrich, St. Louis, Mo., (e.g., SPAN® 20, SPAN® 60, SPAN® 80, and SPAN® 85).

A non-limiting example of a suitable inorganic black pigment includes carbon black. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® L, MONARCH® 700, MONARCH® 800, MONARCH® 880, MONARCH® 900, MONARCH® 1000, MONARCH® 1100, MONARCH® 1300, and MONARCH® 1400); and various black pigments manufactured by Evonik Degussa Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). A non-limiting example of an organic black pigment includes aniline black, such as C.I. Pigment Black 1. Another suitable black pigment is described hereinbelow in reference to FIGS. 5-8.

Some non-limiting examples of suitable yellow pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, and C.I. Pigment Yellow 180.

Non-limiting examples of suitable magenta or red organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Non-limiting examples of cyan organic pigments include C.I. Pigment Blue 1, C.I. Pigment Blue 2, C.I. Pigment Blue 3, C.I. Pigment Blue 15, C.I. Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Non-limiting examples of green organic pigments include C.I. Pigment Green 1, C.I. Pigment Green 2, C.I. Pigment Green, 4, C.I. Pigment Green 7, C.I. Pigment Green 8, C.I. Pigment Green 10, C.I. Pigment Green 36, and C.I. Pigment Green 45.

Non-limiting examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

Examples of white pigments include, but are not limited to, titanium dioxides, TiO₂—SiO₂ core-shell white particles, calcium carbonate particles, CaCO₃—SiO₂ core-shell white particles, ceramic white particles, white clay particles, or other white particles.

The particle cores C₁, C₂ have an average particle size ranging from about 10 nm to about 10 μm. In some instances, the average particle core size ranges from about 10 nm to about 1 μm, or from about 50 nm to about 1 μm.

The particle core C₁ of one of the colorants 12 is surface modified to carry a basic functional group BFG, and the particle core C₂ of the other of the colorants 14 is surface modified to carry an acidic functional group AFG. The acid and base modified colorants 12 may be accomplished via any suitable reaction. While the examples provided herein for achieving surface modification involve phosphoric acid, carboxylic acid, and trialklyamines, it is believed that such surface modification processes may be accomplished using any of the acidic or basic functional groups disclosed herein.

In an embodiment, acidic surface modification is accomplished with a diazonium salt or a silane reagent. As one non-limiting example of the acidic surface modification, phosphoric acidic propylbenzene diazonium salt (e.g., 20 mmol) is added to a suspension of carbon black (e.g., 10 mmol) in water (e.g., 50 mL). The resulting mixture may be stirred at room temperature for a time that is sufficient to enable the reaction (e.g., 24 hours). The mixture is then filtered, and the acid modified carbon black is dried under vacuum. As another non-limiting example of the acidic surface modification, phosphoric acid functionalized triethoxysilane (e.g., 20 mmol) is added to a suspension of silica coated pigment particles (e.g., 10 mmol) in ethanol at room temperature. The resulting mixture is stirred at room temperature for a time that is sufficient to enable the reaction (e.g., 24 hours). The mixture is then filtered, and the acid modified silica coating pigments are dried under vacuum. As still another non-limiting example, carboxylic acidic propylbenzene diazonium salt (e.g., 20 mmol) is added to a suspension of carbon black (e.g., 10 mmol) in water (e.g., 50 mL). The resulting mixture is stirred at room temperature for a time that is sufficient to enable the reaction (e.g., 24 hours). The mixture is then filtered, and the acid modified carbon black is dried under vacuum.

In an embodiment, basic surface modification is accomplished with a silane reagent. As one non-limiting example, trialkylamine functionalized triethoxysilane (20 mmol) is added to a suspension of silica coated pigment particles (10 mmol) in ethanol at room temperature. The resulting mixture is stirred at room temperature for a time that is sufficient to enable the reaction (e.g., 24 hours). The mixture is then filtered, and the trialklyamine modified silica coated pigments are dried under vacuum.

Generally, the acidic functional group AFG and the basic functional group BFG are each present in an amount ranging from about 0.1 wt % to about 20 wt % of a total wt % of the ink. In another embodiment, the functional groups AFG, BFG are each present in an amount ranging from about 0.5 wt % to about 20 wt %.

The acidic functional group AFG is selected from OH, SH, COOH, CSSH, COSH, SO₃H, PO₃H, OSO₃H, OPO₃H, and combinations thereof. In some embodiments, it is desirable to select an acidic functional group AFG having an acidity that enables the AFG to readily react with the selected basic functional group BFG and less readily aggregate in the selected carrier fluid.

The basic functional group BFG is selected from trialkyamines, pyridines, substituted pyridines, imidazoles, substituted imidazoles, or R₁R₂N— where R₁ and R₂ are each independently selected from a hydrogen group, a methyl group, an ethyl group, a propyl group, an isopropyl group, a butyl group, an iso-butyl group, an n-octyl group, an n-decyl group, an n-dodecyl group, an n-tetradecyl group, and combinations thereof.

It is to be understood that either of the particle cores C₁, C₂ may be functionalized with the acidic functional group AFG, as long as the other of the particle cores C₂, C₁ is functionalized with the basic functional group BFG.

When the functionalized colorants 12, 14 are added to the non-polar carrier fluid, an acid-base reaction takes place. The colorants 12, 14 are specifically selected so that the functional groups AFG, BFG interact and a proton transfer from the surface of one colorant (i.e., the colorant 14 including the acidic group AFG) to another colorant (i.e., the colorant 12 including the basic group BFG) results. This reaction generates a positively charged colorant 12′ and a negatively charged colorant 14′.

While not shown in FIG. 1, it is to be understood that the dual color electrically addressable ink may also include a sterically hindering charge controlling agent. The charge controlling agents are selected to improve the performance of dual color ink, such as ink stability, color density, and switching speed. Any polymeric surfactant that can interact with surface functionalized pigments 12′, 14′ to improve the zeta potentials of the ink may be selected as charge controlling agents. The polymeric surfactant sterically hinders the colorants 12′, 14′ thereby preventing the oppositely charged colorants 12′, 14′ from recombining to form a neutral species.

The molecular weight of suitable charge controlling agents ranges from about 1000 to about 15000. In one non-limiting example, the molecular weight of the charge controlling agent is about 3000. Specific examples of such polymeric surfactants include disersants, such as hyper-dispersants from Lubrizol Corp., Wickliffe, Ohio (e.g., SP 3000, 5000, 8000, 11000, 12000, 17000, 19000, 21000, 20000, 27000, 43000, etc.), or those commercially available from Petrolite Corp., St. Louis, Mo. (e.g., Ceramar™ 1608 and Ceramar™ X-6146, etc.). In one embodiment, the polymeric surfactant is poly(hydroxyl)aliphatic acid. A reaction scheme for forming poly(hydroxyl)aliphatic acid change controlling agents is shown in FIG. 2. In this particular example, carboxyalkyl aldehyde (where n ranges from 6 to 18) is reacted with Grignard reagents (alkyl magnesium halides, such as RMgI, where R is a methyl group, an ethyl group, or a hexyl group) to produce a hydroxycarboxylic acid (where n ranges from 6 to 18). The acid undergoes condensation and polymerization to produce a desirable polymeric surfactant (wherein n ranges from 6 to 18, and m is an integer ranging from 3 to 150).

FIG. 3 illustrates two different examples of the particle cores C₁, C₂ that may be selected. In this example, magenta and black are selected as the respective core pigment particles C₁ and C₂, or cyan and yellow are selected as the respective core pigment particles C₁ and C₂. The magenta or cyan particle core C₁ is surface modified with NH₂ as the basic functional group BFG, and the black or yellow particle core C₂ is surface modified with PO₃H the acidic functional group AFG. The phosphoric acid functional group may be particularly desirable in these examples because the acidity is such that the group preferentially reacts with the amine group and is less likely to aggregate in the selected non-polar carrier fluid.

As shown in FIG. 3, the basic surface modified magenta or cyan 12 reacts with the acidic surface modified black or yellow 14 to generate positively charged magenta or cyan colorants 12′ and negatively charged black or yellow colorants 14′. While a dual color system including magenta and black or cyan and yellow is shown in FIG. 3, it is to be understood that these are non-limiting examples of the colors that may be selected, and that other combinations of colors and charges present on the colors are within the purview of the present disclosure.

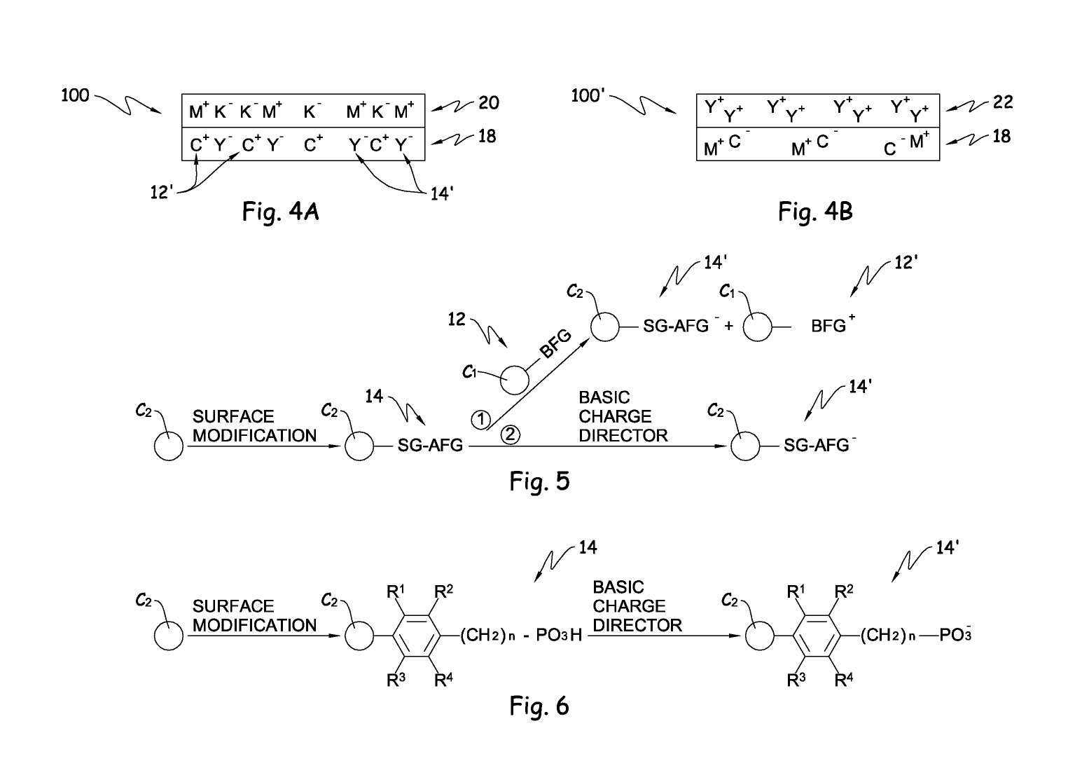

The electrically addressable ink including both the positively and negatively charged particles 12′, 14′ may be incorporated into a multi-layered system 100. A non-limiting example of such a system 100 is shown in FIG. 4A. It is to be understood that this system 100 may be incorporated into a display (the additional components of which are not shown). The system 100 shown in FIG. 4A includes two layers 18, 20, each of which includes a different dual color electronically addressable ink. This particular non-limiting example includes one layer 18 with positively charged cyan colorants C⁺ and negatively charged yellow colorants Y₋, and a second layer 20 with positively charged magenta colorants M⁺ and negatively charged black colorants K⁻. The various colorants may be formed via the methods described in reference to FIGS. 1 and 3, and thus each of the layers 18, 20 also include the non-polar carrier fluid, and, in some instances, a charge controlling agent.

In response to a sufficient electric potential or field applied while driving the display in which the multi-layer system 100 is included, the colorants C⁺, Y⁻, M⁺, K⁻ carried by the fluid tend to move and/or rotate to various spots within the viewing area in order to produce desired visible images. The applied field may be changed in order to change the visible images. As previously mentioned, any desirable combination of colors may be used.

Another non-limiting example of a multi-layer system 100′ is shown in FIG. 4B. It is to be understood that this system 100′ may also be incorporated into a display. The system 100′ shown in FIG. 4B includes two layers 18, 22, one (i.e., 18) of which includes the dual color electronically addressable ink, and the other of which (i.e., 22) includes a single color electronically addressable ink. This particular non-limiting example provides the subtractive primary colors by including positively charged magenta colorants M⁺ and negatively charged cyan colorants C⁻ in the dual color layer 18, and positively charged yellow colorants Y⁺ in the single color layer 22. When a single color layer 22 is used in combination with a dual color layer 18, it may be desirable that the colors of the dual color layer 18 be different than the color selected for the single color layer 22. Again, any desirable combination of colors may be used.

The multi-layer systems 100, 100′ may be used in a variety of applications, including electronic signage, electronic skins, wearable computer screens, electronic paper, and smart identity cards.

One example of an acidic surface modified black colorant 14 is described in reference to FIGS. 5-8. It is to be understood that this particular colorant 14 may be used in the dual color ink described herein, or may be used in combination with a basic charge director in a black electronic ink.

FIG. 5 illustrates the basic scheme for forming the acidic surface modified black colorant 14. A black particle core C₂ is first selected from any black pigment that is dispersible (either self-dispersing or with the aid of an additional dispersant) in the selected non-polar carrier fluid (which may be selected from any of those previously discussed). The black particle core C₂ may be an organic black pigment, such as those commercially available from BASF Corp., Florham Park, N.J. (e.g., PALIOGEN® Black L0086, PALIOGEN® Black S0084, PALIOTOL® Black L0080, SICOPAL® Black K 0090, LUMOGEN® Black FK4280, LUMOGEN® Black FK4281, Magnetic Black S 0045, SICOPAL® Black K 0095), or an inorganic black pigment, such as those commercially available from The Shepherd Color Co., Cincinnati, Ohio, (e.g., Black 10C909, Black 20C980, Black 30C940, Black 30C965, Black 411 and Black 444), or various carbon black pigments, such as those commercially available from Cabot Corp., Boston, Mass. Other examples of suitable black colorants include those listed hereinabove.

As shown in FIG. 5, a surface modification reaction takes place to functionalize the surface of the core particle C₂ with the acidic functional group AFG. Any of the acidic functional groups ACF described herein in reference to the dual color ink may be used to formulate the surface modified black colorant 14.

The modification of the core particle C₂ surface may be accomplished by connecting the acidic functional group AFG to the core particle C₂ surface via a spacing group SG. The spacing group SG may be selected from any substituted or unsubstituted aromatic molecular structure such as benzenes, substituted benzenes, naphthalenes, substituted naphthalenes, hetero-aromatic structures (such as, e.g., pyridines, pyrimidines, triazines, furans, and the like), aliphatic chain derivatives (e.g., —(CH₂)_{b}—, —(CH₂)_{b}NH(C)O—, —(CH₂)_{b}O(CH₂)ₐ—, or —(CH₂)_{b}NH—, where a ranges from 0 to 3, and b ranges from 1 to 10), and/or an inorganic coatings established on the core particle C₂ surface. In a non-limiting example, a single acidic functional group AFG is connected to the spacing group SG (as shown in the mechanism depicted in FIG. 5). In other non-limiting examples, two or more of the acidic functional groups AFG may be connected to a single spacing group SG (not shown in the figures).

Once the surface modification reaction takes place, the acid functionalized colorant 14 may be added to the non-polar carrier fluid in the presence of a base functionalized colorant 12 to form the dual colorant ink described herein, which includes positively charged colorants 12′ and negatively charged colorants 14′.

When it is desirable to form a black ink instead of the dual color ink, a basic charge director may be used instead of the base functionalized colorant 12. In this embodiment, the charging of the acid functionalized colorant 14 is accomplished via an acid-base reaction between the charge director and the acid functionalized colorant 14 or via adsorption of negatively charged reverse micelles (formed via the charge director) at the surface of the acid functionalized colorant 14. It is to be understood that the charge director may also be used in the electronic ink to prevent undesirable aggregation of the colorant in the carrier fluid.

The charge director may be selected from small molecules or polymers that are capable of forming reverse micelles in the non-polar carrier fluid. Such charge directors are generally colorless and tend to be dispersible or soluble in the carrier fluid.

In a non-limiting example, the charge director is selected from a neutral and non-dissociable monomer or polymer such as, e.g., a polyisobutylene succinimide amine, which has the following molecular structure:

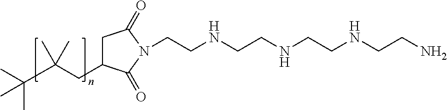

where n is selected from a whole number ranging from 15 to 100.

Another example of the charge director includes an ionizable charge director that is capable of disassociating to form charges. Non-limiting examples of such charge directors include sodium di-2-ethylhexylsulfosuccinate and dioctyl sulfosuccinate. The molecular structure of dioctyl sulfosuccinate is as follows:

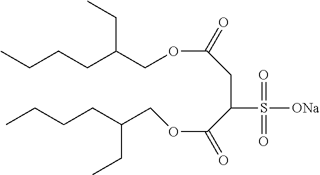

Yet another example of the charge director includes a zwitterion charge director such as, e.g., Lecithin. The molecular structure of Lecithin is as shown as follows:

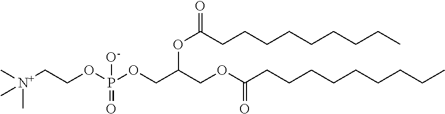

Still another example of the charge director includes a non-chargeable, neutral charge director that cannot disassociate or react with an acid or a base to form charges. Such charge director may advantageously be used in embodiments where the colorant particle 14 is charged via adsorption of reverse micelles on the surface of the colorant particle. A non-limiting example of such a charge director includes fluorosurfactants having the following molecular structure:

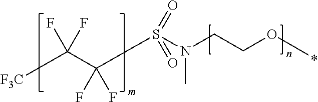

where m is selected from a whole number ranging from 10 to 150, n is selected from a whole number ranging from 5 to 100, and * refers to a repeating base unit.

The example shown in FIG. 6 is the mechanism used to form a black electronic ink. In this example, the surface of the core particle C₂ is acid modified with PO₃H using a substituted benzene derivative as the spacing group SG that has the following molecular structure:

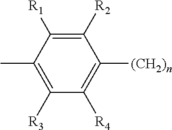

where R₁, R₂, R₃, and R₄ are each independently selected from i) hydrogen, ii) one of a substituted or unsubstituted alkyl group, an alkenyl group, an aryl group, an alkyl group, or iii) one of a halogen, —NO₂, —O—R_{d}, —CO—R_{d}, —CO—O—R_{d}, —O—CO—R_{d}, —CO—NR_{d}Rₑ, —NR_{d}Rₑ, —NR_{d}—CO—Rₑ, —NR_{d}—CO—O—Rₑ, NR_{d}—CO—NRₑR_{f}, —SR_{d}, —SO—R_{d}, —SO₂—R_{d}, —SO₂—O—R_{d}, —SO₂NR_{d}Rₑ, or a perfluoroalkyl group. The letters R_{d}, Rₑ, and R_{f} are each independently selected from i) hydrogen, or ii) one of a substituted alkyl group, an alkenyl group, an aryl group, or an alkyl group. Also, the letter n in the benzene derivative may be any whole number ranging from 0 to 6.

The phosphoric acid surface modified black core particle 14 is then reacted (within the carrier fluid) with the basic charge director to impart a negative charge on the resulting colorant 14′. This charging may be the result of an acid-base reaction, or the adsorption of negatively charged micelles formed by the charge director.

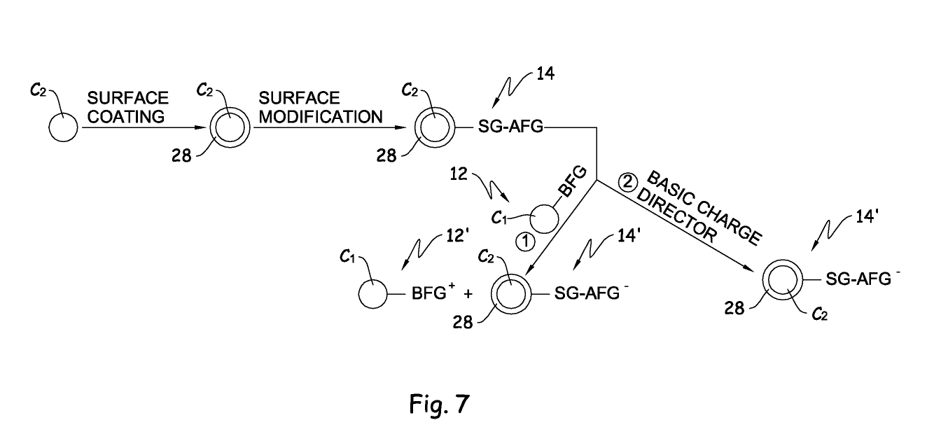

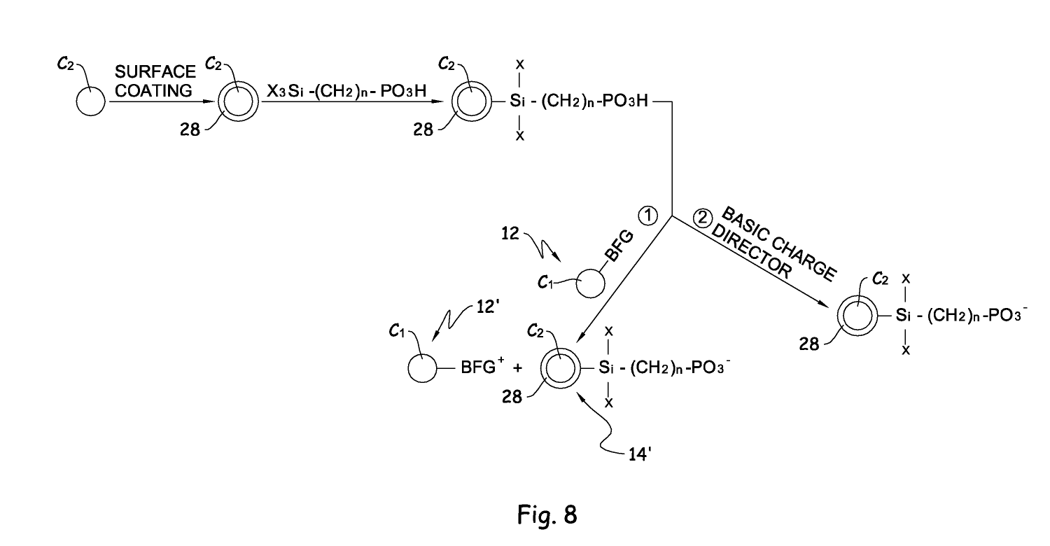

Referring now to FIGS. 7 and 8, the black core particle C₂ (suitable for use in either the dual color or the single color inks disclosed herein) may be coated with a thin metal oxide coating 28 prior to acidic surface functionalization. This coating 28 may be a SiO₂ coating, a TiO₂ coating, an HfO₂ coating, an Al₂O₃ coating, a ZrO₂ coating, a ZnO coating, a MgO coating, a CaO coating, a B₂O₃ coating, and/or the like. The thickness of such coating 28 may range from about 1 nm to about 100 nm. Any known process for applying the coating 28 may be used, some of which are described in U.S. Pat. No. 3,895,956, U.S. Pat. No. 4,002,590, U.S. Pat. No. 4,117,197, U.S. Pat. No. 4,153,591, and EP 0247910.

Once the desirable coating 28 is applied to the black core particle C₂, a surface modification reaction takes place to functionalize the coated surface of the core particle C₂ with the acidic functional group AFG. Any of the acidic functional groups ACF described herein in reference to the dual color ink may be used to formulate the surface modified black colorant 14.

The modification of the coated core particle C₂ may be accomplished by connecting the acidic functional group AFG to the core particle C₂ surface via any of the previously described spacing groups SG. As shown in FIG. 8, the selected spacing group SG is X₃Si—(CH₂)ₙ, where X represents a halogen (e.g., Cl, Br, etc.), a methoxy group (e.g., a trimethoxy group), an ethoxy group (e.g., a triethoxy group), or another alkyloxy group (e.g., a tripropoxy group), and the letter n represents any whole number ranging from 1 to 20.

Once the surface modification reaction takes place, the acid functionalized colorant 14 may be added to the non-polar carrier fluid in the presence of a base functionalized colorant 12 to form the dual colorant ink described herein, which includes positively charged colorants 12′ and negatively charged colorants 14′.

When it is desirable to form a black ink instead of the dual color ink, any of the basic charge directors disclosed herein may be used instead of the base functionalized colorant 12 to impart negative charges on the acid functionalized colorant 14.

It is to be understood that the black electronic ink may include any of the charge controlling agents disclosed herein.

It is to be further understood that any of the embodiments of the electrically addressable/electronic inks disclosed herein may be made using any suitable method known by those skilled in the art. Some non-limiting examples of such methods include grinding, milling, attriting, via a paint-shaker, microfluidizing, ultrasonic techniques, and/or the like.

Still further, the amounts of each of the components used to form the inks disclosed herein may vary, depending at least in part, on the desirable amount to be made, the application in which it will be used, etc. In one embodiment, the colorants are present in the same (or substantially the same (i.e., within ±5 wt. %)) amount as each other. When present, a polymeric dispersant is often included in the same amount as, substantially the same amount as, or an amount less than the total wt. % of the colorants used.

To further illustrate embodiment(s) of the present disclosure, the following examples are given herein. It is to be understood that these examples are provided for illustrative purposes and are not to be construed as limiting the scope of the disclosed embodiment(s).

### EXAMPLES

### Example 1

About 60 mg of carboxylic acid surface modified carbon black, about 60 mg of trialkylamine surface modified magenta pigment, and about 120 mg of polyisobutylenesuccinimide were mixed in about 6 g of halogenated solvent, giving rise to an electronic ink, in which the two color pigments each respond to the opposite polarity of an electrode.

### Example 2

About 60 mg of carboxylic acid surface modified carbon black, about 60 mg of trialkylamine surface modified magenta pigment, and about 120 mg of polyisobutylenesuccinimide were mixed in about 6 g of isoparaffinic fluid, giving rise to an electronic ink, in which the two color pigments each respond to the opposite polarity of an electrode.

It is to be understood that the carboxylic acid functionalized carbon black pigment CB used in Examples 1 and 2 may be made by adding carboxylic acidic propylbenzene diazonium salt (20 mmol) to a suspension of carbon black (10 mmol) in water (50 mL). The resulting mixture is stirred at room temperature for about 24 hours. Then the mixture is filtered off and dried in vacuum to afford the acid modified carbon black.

### Example 3

About 60 mg of phosphoric acid surface modified carbon black, about 60 mg of trialkylamine surface modified magenta pigment, and about 120 mg of polyisobutylenesuccinimide are mixed in about 6 g of halogenated solvent, giving rise to an electronic ink in which the two color pigments each respond to the opposite polarity of an electrode.

### Example 4

About 60 mg of phosphoric acid surface modified carbon black, about 60 mg of trialkylamine surface modified magenta pigment, and about 120 mg of polyisobutylenesuccinimide are mixed in about 6 g of isoparaffinic fluid, giving rise to an electronic ink in which the two color pigments each respond to the opposite polarity of an electrode.

While several embodiments have been described in detail, it will be apparent to those skilled in the art that the disclosed embodiments may be modified. Therefore, the foregoing description is to be considered exemplary rather than limiting.

1. A dual color electronically addressable ink, comprising:
a non-polar carrier fluid;
a first colorant of a first color, the first colorant including:
a particle core; and
a basic functional group attached to a surface of the particle core; and
a second colorant of a second color that is different than the first color, the second colorant including:
a particle core; and
an acidic functional group attached to a surface of the particle core;
wherein the acidic functional group and the basic functional group are configured to interact within the non-polar carrier fluid to generate a charge on the first colorant and an opposite charge on the second colorant.

2. The dual color electronically addressable ink as defined in claim 1, further comprising a charge controlling agent.

3. The dual color electronically addressable ink as defined in claim 1 wherein the acidic functional group and the basic functional group are each present in an amount ranging from about 0.1 wt % to about 20 wt % of a total wt % of the ink.

4. The dual color electronically addressable ink as defined in claim 3 wherein the acidic functional group is selected from OH, SH, COOH, CSSH, COSH, SO₃H, PO₃H, OSO₃H, OPO₃H, and combinations thereof.

5. The dual color electronically addressable ink as defined in claim 3 wherein the basic functional group is selected from a trialkyamine, pyridines, substituted pyridines, imidazoles, substituted imidazoles, R₁R₂N—, wherein R₁ and R₂ are each independently selected from a hydrogen group, a methyl group, an ethyl group, a propyl group, an isopropyl group, a butyl group, an iso-butyl group, an n-octyl group, an n-decyl group, an n-dodecyl group, and an n-tetradecyl group, and combinations thereof.

6. The dual color electronically addressable ink as defined in claim 1 wherein:
the particle core of the second colorant is selected from organic black pigments, inorganic black pigments, and carbon black pigments; and
a spacing group attaches the acidic functional group to the particle core.

7. The dual color electronically addressable ink as defined in claim 6 wherein the second colorant further includes a metal oxide coating established on the particle core.

8. The dual color electronically addressable ink as defined in claim 1 wherein mobile charges in the ink include the charged first and second colorants.

9. A multi-layer system, comprising:
a first layer including the dual color electronically addressable ink as defined in claim 1; and
a second layer including i) the dual color electronically addressable ink as defined in claim 1, wherein the first and second colors of the first layer are different than the first and second colors of the second layer, or ii) a single color electronically addressable ink, wherein the first and second colors of the first layer are different than a color of the second layer.

10. A method of making a dual color electronically addressable ink, comprising:
incorporating two different colored colorants into a non-polar carrier fluid, a first of the two different colored colorants being functionalized with a basic group and a second of the two different colored colorants being functionalized with an acidic group;
allowing the acidic group and the basic group to undergo an acid-base reaction such that the acidic group carries a negative charge and the basic group carries a positive charge; and
incorporating a sterically hindering charge controlling agent into the non-polar carrier fluid to prevent the oppositely charged colorants from recombining to form a neutral species.

11. The method as defined in claim 10, further comprising selecting a strength of the acidic group such that the acidic group preferentially reacts with the basic group without aggregating in the non-polar carrier fluid.

12. An electronic ink, comprising:
a non-polar carrier fluid;
a plurality of black colorant particles dispersed in the non-polar carrier fluid, each of the black colorant particles including:
a core colorant particle selected from organic black pigments, inorganic black pigments, and carbon black pigments;
a spacing group attached to the core colorant particle; and
an acidic functional group attached to the spacing group; and
one of: a basic charge director capable of forming reverse micelles in the non-polar carrier fluid or an other colorant particle having a basic functional group attached to a surface thereof, the one of the basic charge director or the other colorant particle configured to impart a negative charge on the black colorant particles.

13. The electronic ink as defined in claim 12 wherein the black colorant particles further include a metal oxide layer established directly on a surface thereof.

14. The electronic ink as defined in claim 12 wherein the spacing group is selected from substituted or unsubstituted aromatic molecular structure, an inorganic coating, or an aliphatic chain derivative selected from —(CH₂)_{b}—, —(CH₂)_{b}NH(C)O—, —(CH₂)_{b}O(CH₂)ₐ—, or —(CH₂)_{b}NH—, where a ranges from 0 to 3, and b ranges from 1 to 10.

15. The electronic ink as defined in claim 12 wherein the plurality of black colorant particles is formed by reacting the core colorant particle with X₃Si—(CH₂)ₙ-AFG, wherein X is selected from a halogen and an alkyloxy group, n ranges from 1 to 20, and AFG is selected from OH, SH, COOH, CSSH, COSH, SO₃H, PO₃H, OSO₃H, OPO₃H, and combinations thereof.

16. The multi-layer system as defined in claim 9 wherein the dual color electronically addressable ink of the first layer further includes a charge controlling agent.

17. The multi-layer system as defined in claim 9 wherein the acidic functional group and the basic functional group are each present in an amount ranging from about 0.1 wt % to about 20 wt % of a total wt % of the dual color electronically addressable ink of the first layer.

18. The method as defined in claim 10, further comprising:
selecting the acidic functional group from OH, SH, COOH, CSSH, COSH, SO₃H, PO₃H, OSO₃H, OPO₃H, and combinations thereof; and
selecting the basic functional group from a trialkyamine, pyridines, substituted pyridines, imidazoles, substituted imidazoles, R₁R₂N—, wherein R₁ and R₂ are each independently selected from a hydrogen group, a methyl group, an ethyl group, a propyl group, an isopropyl group, a butyl group, an iso-butyl group, an n-octyl group, an n-decyl group, an n-dodecyl group, and an n-tetradecyl group, and combinations thereof.
